(19) United States
(12) Patent Application Publication
(10) Pub. No.: US 2023/0352870 A1
(43) Pub. Date: Nov. 2, 2023

(54) MODULAR CONNECTOR

(71) Applicant: Stäubli Electrical Connectors AG, Allschwil (CH)

(72) Inventors: Alexander DOPPLER, Allschwil (CH); Sylvestre KIRY, Leymen (FR); Denis MENIN, Orbey (FR); Hervé MULLER, Eguisheim (FR)

(73) Assignee: Stäubli Electrical Connectors AG, Allschwil (CH)

(21) Appl. No.: 18/002,124

(22) PCT Filed: Jun. 8, 2021
(86) PCT No.: PCT/EP2021/065243

§ 371 Date: Dec. 16, 2022

(30) Foreign Application Priority Data
Jun. 18, 2020 (EP) 20180815.1
Jun. 18, 2020 (EP) 20180821.9

(51) Int. Cl. H01R 13/422; H01R 13/518; H01R 13/64

(52) U.S. Cl. CPC H01R 13/422; H01R 13/518; H01R 13/64

(57) ABSTRACT

A connector having a contact carrier and a plurality of contact elements which are mounted in the contact carrier, wherein the contact carrier has a front wall and a rear wall which are connected to one another via side walls, wherein the walls define a receiving space, wherein holding webs extend through the receiving space, which holding webs each have fastening sections as well as a clamping section which is situated between the fastening sections, wherein the holding webs have at least one clamping structure in the clamping section. One contact element is clamped in an intermediate space between two adjacent holding webs by the at least one clamping structure, and at least one of the fastening sections has the structure of a joint in such a way that the holding web can be moved from a clamping position to a release position by elastic deformation of the joint.

### TECHNICAL FIELD

The present invention relates to a connector as claimed in the preamble of claim 1.

### PRIOR ART

DE 20 2013 000 969 U1 discloses a connector which has a plurality of contact elements which are retained in a housing via latching elements. Each of the contact elements can here be inserted individually into a corresponding receptacle.

A disadvantage of DE 20 2013 000 969 U1 is that the contact elements can be inserted and removed only by using a relatively large amount of force.

GB 1 491 217 discloses a further connector in which the contact elements are retained by spring tabs. The spring tabs are held in their clamping position by means of a closing element.

GB 1 491 217 has the advantage compared with DE 20 2013 000 969 U1 that the contact element can be removed from the receptacle and inserted into the receptacle more easily. However, inserting and removing the contact element is complicated because the closing element needs to be manipulated as well.

A further disadvantage is that the subject-matter of DE 20 2013 000 969 U1 and GB 1 491 217 are complicated to produce and mount, in the latter case especially with regard to the complex mechanical design with multiple parts.

### SUMMARY OF THE INVENTION

Starting from this prior art, the object of the invention is to provide a connector which overcomes the disadvantages of the prior art. In particular, it is a preferred object to provide a connector with contact elements which can be assembled and disassembled easily.

This object is achieved by the subject-matter of claim 1. Accordingly, a connector comprises a contact carrier and a plurality of contact elements which are mounted in the contact carrier and extend along a center axis. The contact carrier has a front wall and a rear wall which are connected to each other via side walls, wherein the front wall, the rear wall, and the side walls define a receiving space. At least one retaining web extends from the front wall to the rear wall through the receiving space. A plurality of retaining webs running parallel to one another can also be present. The at least one retaining web has in each case a front fastening section and a rear fastening section, as well as a clamping section situated between the fastening sections. The at least one retaining web has in the clamping section at least one clamping structure by means of which in each case one contact element is clamped in an intermediate space between two adjacent retaining webs and/or by means of which in each case one contact element is retained in an intermediate space between a retaining web and one of the side walls. At least one of the fastening sections has the structure of a flexure hinge in such a way that, when the contact element is inserted and/or removed, the retaining web can be moved by elastic deformation of the flexure hinge from a clamping position into a release position.

Simple assembly and disassembly of the contact elements is enabled by the arrangement of the flexure hinge. Determined locations are created which can deform elastically during assembly and disassembly.

A determined hinge is created by the arrangement of the flexure hinge, as a result of which it is made possible that a contact element can be assembled and disassembled at all times under the same conditions.

In other words, the retaining web is deflected out of the clamping position and into the release position.

The term “flexure hinge” is understood to mean a hinge which enables a relative movement between the front wall and the clamping section or between the rear wall and the clamping section. When a force is applied, the flexure hinge is deformed elastically from the clamping position into the release position and reassumes the clamping position when the force ceases. The flexure hinge can be deformed by deflecting or torsion. A combination of deflecting and torsional deformation is also conceivable.

The term “retained” is understood to mean mechanically holding the contact element in the intermediate space. For example, the contact element is clamped and/or engaged in place.

A plurality of retaining webs are preferably present in the receiving space and thus a plurality of intermediate spaces can be provided for the contact elements.

The contact bearing is preferably made from plastic, wherein the contact carrier is preferably produced using an injection-molding process.

The contact element is preferably an electrical contact element or a pneumatic contact element or a hydraulic contact element or an optical contact element.

When the retaining web moves, the clamping section preferably also undergoes deformation, in particular elastic deformation, in addition to the at least one flexure hinge. The degree of deformation of the clamping section is preferably less than the degree of deformation of the at least one flexure hinge.

The flexure hinge preferably has a cross-sectional area which is smaller than the cross-sectional area of the clamping section.

This design ensures that the deformation is actually effected in the flexure hinge when the force is applied. The clamping section is correspondingly designed to be more robust than the flexure hinge and accordingly is not deformed or only slightly deformed.

The cross-sectional area of the flexure hinge preferably corresponds to 15% to 75%, in particular 25% to 60%, of the maximum cross-sectional area of the clamping section.

The front fastening section is preferably integrally formed on the front wall and the rear fastening section is preferably integrally formed on the rear wall.

The extent of the retaining web between the front wall and the rear wall is preferably defined as the length, the extent between two adjacent intermediate spaces as the width, and the extent transversely to the length as the height, wherein the width of the clamping section is the same as the width of the flexure hinge, and wherein the height of the clamping section is greater than the height of the flexure hinge.

A flexure hinge which is easy to deform can be provided by this design.

The clamping section preferably extends in the direction of height away from the flexure hinge on both sides. The width is preferably less than the height.

When activated, the flexure hinge undergoes a torsional movement about an axis which runs parallel to the center axis of the contact element and centrally through the flexure hinge and a deflecting movement away from the contact element or transversely to the axis. The axis preferably runs through the center point of the cross-sectional area of the flexure hinge. The cross-sectional area of the flexure hinge in the direction of the said axis is preferably constant.

The transition between the flexure hinge and the front wall and/or between the flexure hinge and the rear wall is preferably designed so that it is rounded with a rounding.

Stress peaks which result during the deformation are easily dissipated by the rounding.

The clamping section preferably has an activating tab via which a force can be exerted on the retaining web in such a way that the retaining web can move from the clamping position into the release position.

Viewed in the direction of the retaining web, the activating tabs of two adjacent retaining webs are situated at the same position on the respective retaining webs in such a way that the two retaining webs are moved apart from each other from the clamping position into the release position by a tool which can be positioned between the activating tabs and acts via the two activating tabs.

Preferably the side wall has an activating tab or the side wall provides an activating tab, wherein the adjacent retaining web is moved away from the side wall from the clamping position into the release position by a tool which acts on the activating tab of the side wall and the activating tab of the retaining web adjacent to the side wall.

The activating tab preferably extends over the whole length or part of the length of the clamping section.

The contact element is preferably designed externally with an essentially cylindrical shape, wherein the contact element has at least one recess in which the clamping structure engages.

The clamping structure preferably has at least one hook, wherein the hook has a concave rounding for receiving the contact element, and wherein the concave rounding, viewed in cross-section transversely to the center axis, has essentially the shape of a segment of a circle, in particular essentially the shape of a quarter circle.

The hook accordingly engages around the contact element and thus retains it in the intermediate space.

Two hooks are preferably in each case arranged, situated opposite each other with respect to the intermediate space, on two adjacent retaining webs or the side wall, and form a hook pair, wherein one hook engages around the contact element from below with respect to the center axis and the other hook engages around the contact element from above with respect to the center axis.

The hooks of a hook pair preferably engage around the contact element in each case with different wrap angles. As a result, the contact element can be loosened more easily.

At least two hook pairs are preferably arranged so that they are offset relative to each other in the direction of the center axis of the contact element or the retaining web or the side wall, wherein the length of the hooks is the same or different between the individual hook pairs.

The mounting of the contact element can be improved by the offset arrangement.

The clamping structure furthermore preferably has a safety element, which provides a stop means with respect to movement of the contact element in the direction of the center axis of the contact element, on the retaining web or on the side wall.

The safety element projects, for example, into one of the said recesses.

On the surface facing the receiving space, the side walls preferably have a clamping structure which has an essentially identical or similar design to that of the clamping structure on the retaining webs.

The front wall and the rear wall preferably have an opening per contact element via which access to the contact element is provided. In each case two adjacent openings are preferably situated so that they are offset downward and upward relative to each other. As a result, the contact elements also come to be situated offset relative to each other. The clamping structures which project into two receiving spaces situated adjacent to each other are also correspondingly situated so that they are offset relative to each other.

Particularly preferably, the contact element is an electrical contact element and has a front-side contact section which is designed as a socket part or pin part. The contact element furthermore has a rear-side contact section which is designed for connection to a cable.

The contact carrier preferably has clamping tabs on the outside by means of which the contact carrier can be clamped to a retaining frame.

A first contact carrier preferably has in the region of the front wall a receptacle into which a guide section of a further contact carrier can be pushed. The receptacle can also serve as a protection for those parts of the contact elements which project into the receptacle.

In the region of the front wall and in a subregion of the side wall, the further contact carrier preferably has a guide section which can be pushed into a receptacle of a further contact carrier.

Further embodiments are provided in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a perspective view of two connectors which can be connected to each other, according to an embodiment of the present invention;

FIG. 2 shows a further perspective illustration of the two connectors according to FIG. 1;

FIG. 3a, 3b show further perspective illustrations of the two connectors according to FIG. 1;

FIG. 4 shows a front view of the two connectors according to FIG. 1;

FIG. 5 shows an illustration in section of the two connectors according to FIG. 1;

FIG. 6 shows a side view of one of the connectors according to FIG. 1;

FIG. 7 shows an illustration in section of one of the connectors according to FIG. 1; and

FIG. 8 shows a perspective view of a connector system with a connector of the preceding figures.

### DESCRIPTION OF PREFERRED EMBODIMENTS

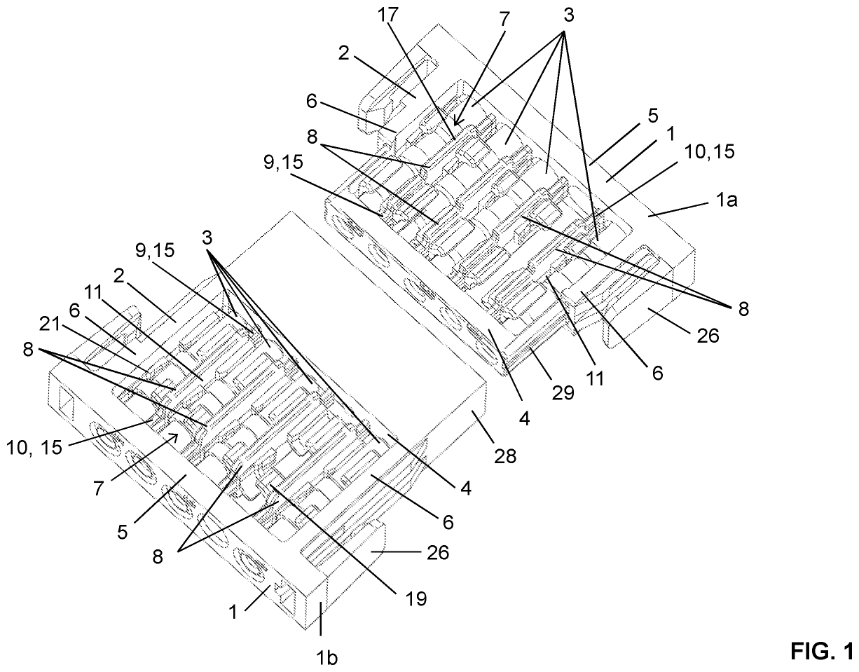

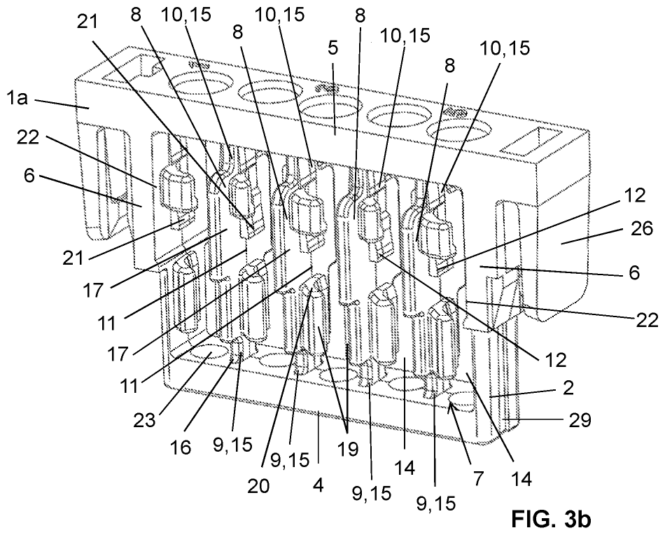

Different views of a connector 1 are shown in FIGS. 1 to 7. In the embodiments shown, the connector is shown in each case as a socket side 1a or a pin side 1b. The essential features of the connector 1 on the socket side 1a are essentially identical to those on the pin side 1b. Consequently, reference is made in each case just to the connector 1, this meaning both the socket side 1a and the pin side 1b equally.

The connector 1 comprises a contact carrier 2 and a plurality of contact elements 3 mounted in the contact carrier 2. The contact elements 3 extend along a center axis M. The contact elements 3 are here illustrated as electrical contact elements 3. However, pneumatic, hydraulic, or optical contact elements can also be used.

The contact carrier 2 has a front wall 4 and a rear wall 4 which are connected to each other via side walls 6. The front wall 4, the rear wall 5, and the side walls 6 define a receiving space 7. The contact elements 3 are situated in the receiving space 7. Furthermore, a plurality of retaining webs 8 extend through the receiving space 7 from the front wall to the rear wall 5. The retaining webs 8 each have a front fastening section 9 and a rear fastening section 10, as well as a clamping section 11 situated between the fastening sections 9, 10. The contact element 3 is retained in the receiving space 7 via the clamping section 11.

The front fastening section 9 is integrally formed on the front wall 4, and the rear fastening section 10 is integrally formed on the rear wall 5. This means that the fastening sections 9, are connected to the front wall 4 and to the rear wall 5 as a single piece. The front wall 4 and the rear wall 5 are likewise integrally connected to the side walls 6. The retaining webs 8 have at least one clamping structure 12 in the clamping section 11. By means of the clamping structure 12, in each case one contact element 3 is retained in clamping fashion in an intermediate space 14 between two adjacent retaining webs 8 or in the intermediate space 14 between a retaining web 8 and the side wall 8.

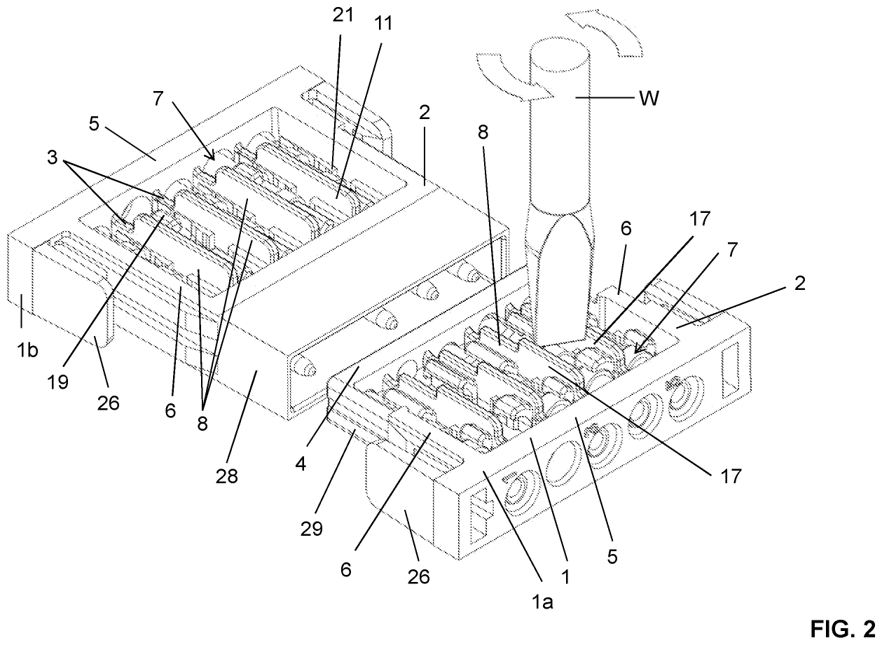

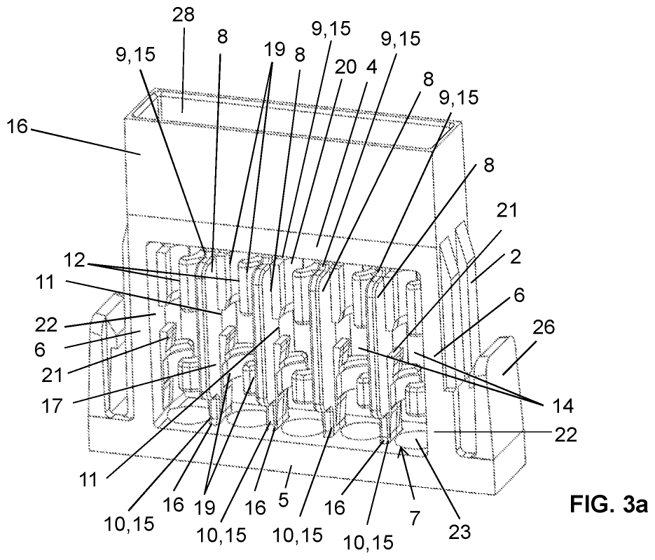

The at least one fastening section 9, 10 has the structure of a flexure hinge 15. In the embodiment shown, both fastening sections 9, 10 have the form of a flexure hinge 15. As can be readily seen in FIGS. 3a and 3b, the flexure hinge 15 is designed in such a way that, during insertion and/or removal of the contact element 3, the retaining web 8 can be moved from a clamping position into a release position by elastic deformation of the flexure hinge 15. Activation can be effected, for example, by a tool W, as illustrated in FIG. 2.

A determined or specific hinge is provided by the arrangement of the flexure hinge 15. It is consequently possible that assembly and disassembly of the contact element 3 can always be effected under the same conditions. There is a further advantage that a mechanical hinge is present in the form of the flexure hinge which correspondingly enables relative movement between the front wall 4 and the clamping section 11 or between the rear wall 5 and the clamping section 11. The flexure hinge 15 is elastically deformed when a force is applied and thus moves the retaining web 8 or parts of the retaining web 8 from the clamping position into the release position. Depending on the design, the retaining web 8 can also be elastically deformed. The flexure hinge 15 and the retaining web 8 are, however, preferably defined such that the majority of the deformation takes place in the flexure hinge.

When the force ceases, the retaining web 8 and also the flexure hinge 15 reassume the clamping position. This is therefore a case of elastic deformation. The flexure hinge 15 is thus stressed to make a movement that is a combination of deflecting and torsion and is deformed accordingly. Depending on the design, the flexure hinge can also be stressed and deformed only by deflecting or only by torsion.

It can be readily seen in FIGS. 3a and 3b that the flexure hinge 15 has a cross-sectional area which is smaller than the cross-sectional area of the clamping section 11. This means that the flexure hinge 15 is designed so that it tapers relative to the clamping section 11.

The cross-sectional area of the flexure hinge 15 particularly preferably corresponds to up to 65%, in particular 25 to 60%, of the maximum cross-sectional area of the clamping section 11. The maximum cross-sectional area of the clamping section 11 is defined in a region in which the clamping structure 12 is not present.

The extent of the retaining web 8 between the front wall 4 and the rear wall 5 is defined as the length. The extent of the retaining web 8 between two adjacent intermediate spaces 14 is defined as the width. The extent of the retaining web 8 transversely to the length of the retaining web 8 is defined as the height. The width of the clamping section is here essentially the same as the width of the flexure hinge 15. This means that the retaining web 8 has, apart from the clamping structure 12, essentially a constant width between the front wall 4 and the rear wall 5.

The height of the clamping section 11 is here greater than the height of the flexure hinge 15. As a result, the clamping section 11 is designed with a greater robustness than the flexure hinge 15, which is advantageous for the movement of the flexure hinge 15.

The clamping section 11 extends in the direction of height away from the flexure hinge 15 on both sides. This means that the clamping section 11 extends both above and below the flexure hinge 15.

When activated, the flexure hinge 15 undergoes a torsional movement and a deflecting movement in the embodiment shown. The torsional movement takes place about an axis A running parallel to the center axis M of the contact element 3 and centrally through the flexure hinge 15. The deflecting movement takes place transversely to the axis A. As already mentioned, the axis A runs parallel to the center axis A of the contact element 5 and centrally through the flexure hinge 15 and through the retaining web 8.

It can furthermore be seen in FIGS. 3a and 3b that the transition from the flexure hinge 15 to the front wall 4 and the transition from the flexure hinge 15 to the rear wall 5 is designed so that it is rounded with a rounding 16. This design of the transition has the advantage that the stress peaks which result from the elastic deformation of the flexure hinge 15 can be channeled effectively into the front wall 4 or into the rear wall 5.

As shown in the drawings, in particular FIG. 2, the clamping section 11 has an activating tab 17. A force can be exerted on the retaining web 8 and on the flexure hinge 15 via the activating tab 17 which protrudes from the actual clamping section 11. The force can here be exerted in such a way that the retaining web 8 is moved from the clamping position into the release position. In the embodiment shown, a tool W can be placed between two adjacent retaining webs 8, wherein a force can then be exerted on the activating tabs 17 of the two adjacent retaining webs 8 by activation of the tool, in particular by twisting the tool W. In the embodiment shown, the tool W is a screwdriver.

The activating tabs 17 of two adjacent retaining webs 8 are always situated essentially in the same position, viewed in the direction of the retaining web 8, such that the two retaining webs can be moved apart from each other, from the clamping position into the release position, by the tool W which can be positioned between the activating tabs 17 and acts via the activating tabs 17.

It can be readily seen in all the Figures that the contact element 3 is designed externally with an essentially cylindrical shape. The contact element 3 here has at least one recess 18 into which the clamping structure engages.

Details of the clamping structure 12 will now be explained in more detail with reference to FIGS. 3a, 3b, 4, 5, and 7. In the embodiment shown, the clamping structure comprises at least one hook 19, wherein the hook 19 has a concave rounding 20 for receiving the contact element 3. The concave rounding 20 surrounds only part of the contact element, viewed in cross-section about the center axis M. The concave rounding 20 has the shape of a quarter circle in the embodiment shown.

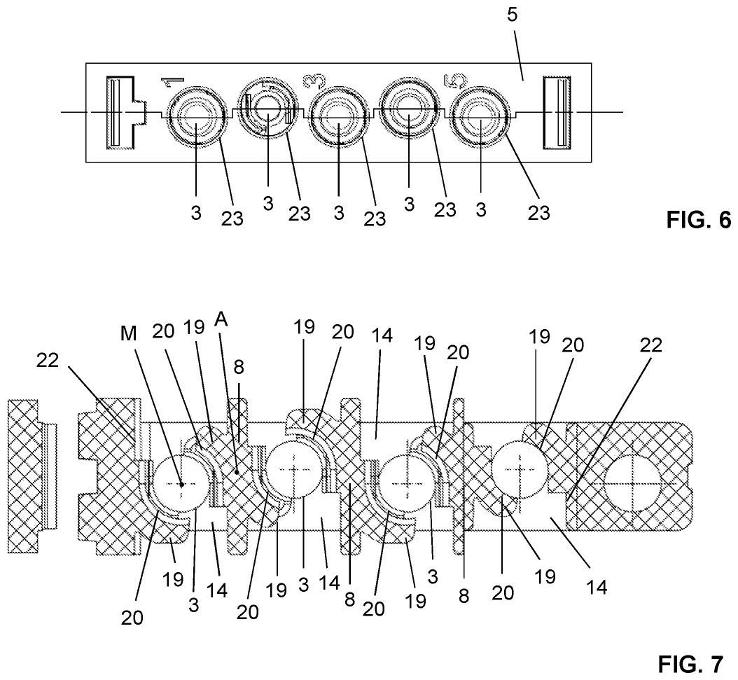

In the embodiment shown, in each case two hooks 19 are arranged on two adjacent retaining webs 8. The two hooks 19 are here arranged so that they are situated opposite each other with respect to the intermediate space 14. These two hooks 19 here form a hook pair. One hook 18 here surrounds the contact element 3 from below and the other hook 19 engages around the contact element 3 from above. This engagement is illustrated correspondingly in FIG. 7. The hooks 19 of a hook pair here hold the contact element 3 in place in the intermediate space 14. The hooks 19 can furthermore also act as positioning aids for the contact element 3.

The hooks 19 are preferably designed such that the contact element 3 is mounted in floating fashion. This means that the contact element is mounted so that it can move easily in the intermediate space 14.

In the embodiment shown, as is shown well in FIGS. 3a and 3b, in each case two hook pairs are arranged so that they are offset relative to each other in the direction of the center axis M of the contact element 3 or in the direction of the retaining web 8. A total of four hooks 18 are arranged per intermediate space 14. The length of the hooks 18 between the individual hook pairs can here be the same or different. This means that two hook pairs engage around the contact element 3 essentially at two locations.

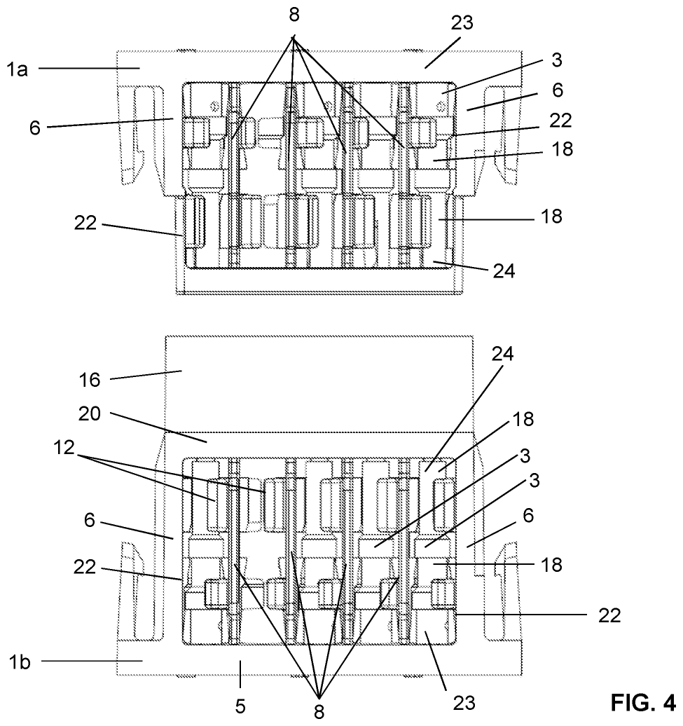

The clamping structure furthermore has a safety element 21 on the retaining web 8. The safety element 21 is designed as a raised portion which extends away from the retaining web 8 and provides a stop means with respect to movement of the contact element 3 in the direction of the center axis M of the contact element 3. This stopping action is shown in FIG. 5. The safety element 21 engages in a recess 18 on the contact element 3.

The side walls 6 also have a clamping structure 12 on the surface which faces the receiving space 7. The clamping structure 12 here has an essentially identical or similar design to that of the clamping structure 12 on the retaining webs 8. This means that in the present case corresponding hooks 19 and the safety element 21 are also present.

The front wall 4 and the rear wall 5 have an opening 23. Access can be provided to the contact element 3 via this opening 23.

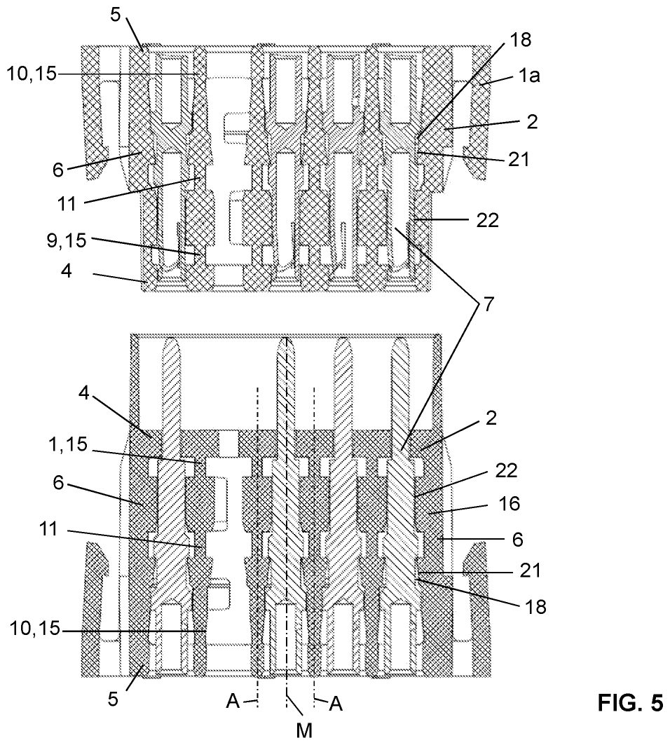

It is shown in FIG. 6 that the openings 23 do not lie on the same axis and instead are each arranged so that they are offset upward and downward relative to each other. This arrangement has the advantage that the retaining webs can be deflected with the expenditure of less force. The spacing between two contact elements situated adjacent to each other is furthermore increased, which in turn has the advantage that electrical crosstalk between the two contact elements can be prevented.

The contact element shown in the figures is an electrical contact element. The electrical contact element has a front-side contact section 24 and a rear-side contact section 25. In the socket side 1a, the front-side contact section 24 is designed as a socket part and in the pin side 1b, the front-side contact section 24 is designed as a pin part. When connected, the pin part projects into the socket part. The rear-side contact section 25 serves to receive a cable.

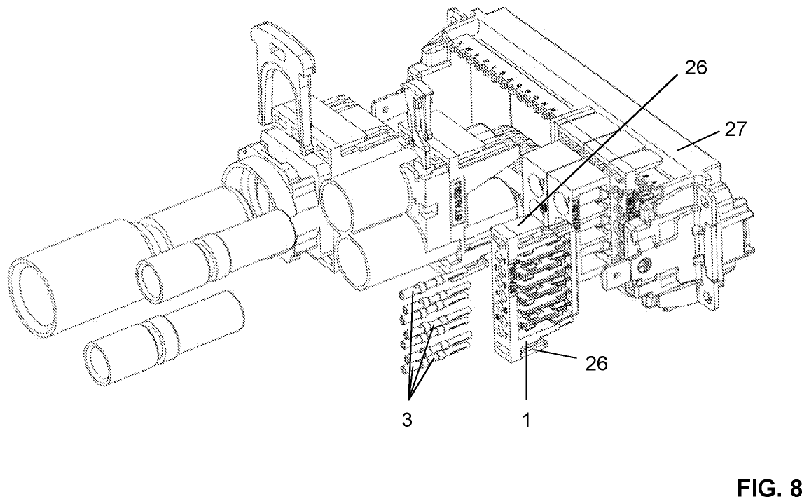

As shown in all the figures, the contact carrier 2 has clamping tabs 26 on the outside. The contact carrier 2 can be clamped to a retaining frame 27 by means of these clamping tabs. An example of a retaining frame 27 is shown in FIG. 8. The retaining frame 27 here has a structure which permits clamping of the contact carrier 2 to the retaining frame 27 by means of the outer clamping tabs 26. In the embodiment shown, further plug parts are also shown.

The contact carrier 2 of the pin side 1b furthermore has a receptacle 28 in the region of the front wall 4. The receptacle 28 here provides a guide for a guide section 29 of the contact carrier 2 of the socket side 1a. The contact carrier 2 of the socket side 1a has, in the region of the front wall 4 and in a subregion of the side wall 6, a guide section 29 which can then be pushed into the receptacle 28 of the contact carrier 1 of the pin side 1b.

LIST OF REFERENCE SIGNS

| | |
|---|---|
| 1 | connector |
| 1a | socket side |
| 1b | pin side |
| 2 | contact carrier |
| 3 | contact elements |
| 4 | front wall |
| 5 | rear wall |
| 6 | side wall |
| 7 | receiving space |
| 8 | retaining webs |
| 9 | front fastening section |
| 10 | rear fastening section |
| 11 | clamping section |
| 12 | clamping structure |
| 14 | intermediate space |
| 15 | flexure hinge |
| 16 | rounding |
| 17 | activating tab |
| 18 | recesses |
| 19 | hook |
| 20 | concave rounding |
| 21 | safety element |
| 22 | surface |
| 23 | opening |
| 24 | front-side contact section |
| 25 | rear-side contact section |
| 26 | clamping tabs |
| 27 | retaining frame |
| 28 | receptacle |
| 29 | guide section |
| M | center axis |
| A | axis |
| W | tool |

1-16. (canceled)

17. A connector comprising a contact carrier and a plurality of contact elements which are mounted in the contact carrier and extend along a center axis (M),
wherein the contact carrier has a front wall and a rear wall which are connected to each other via side walls, wherein the front wall, the rear wall, and the side walls define a receiving space,
wherein at least one retaining web extends from the front wall to the rear wall through the receiving space, said at least one retaining web having in each case a front fastening section and a rear fastening section as well as a clamping section situated between the fastening sections,
wherein the at least one retaining web has in the clamping section at least one clamping structure by means of which in each case one contact element is retained in an intermediate space between two adjacent retaining webs and/or an intermediate space between the at least one retaining web and one of the side walls,
wherein at least one of the fastening sections has the structure of a flexure hinge in such a way that, when the contact element is inserted and/or removed, the retaining web is movable by deformation of the flexure hinge from a clamping position into a release position.

18. The connector as claimed in claim 17, wherein the deformation is an elastic deformation.

19. The connector as claimed in claim 17, wherein, when the retaining web moves, the clamping section also undergoes deformation or elastic deformation in addition to the at least one flexure hinge.

20. The connector as claimed in claim 17, wherein the flexure hinge has a cross-sectional area which is smaller than the cross-sectional area of the clamping section.

21. The connector as claimed in claim 17, wherein the cross-sectional area of the flexure hinge corresponds to 15% to 75% or to 25% to 60% of the maximum cross-sectional area of the clamping section.

22. The connector as claimed in claim 17, wherein the front fastening section is integrally formed on the front wall and wherein the rear fastening section is integrally formed on the rear wall.

23. The connector as claimed in claim 17, wherein the extent of the retaining web between the front wall and the rear wall is defined as the length, the extent between two adjacent intermediate spaces as the width, and the extent transversely to the length as the height, wherein the width of the clamping section is the same as the width of the flexure hinge and wherein the height of the clamping section is greater than the height of the flexure hinge.

24. The connector as claimed in claim 23, wherein the clamping section extends in the direction of height away from the flexure hinge on both sides; and/or wherein the width is less than the height.

25. The connector as claimed in claim 17, wherein, when activated, the flexure hinge undergoes a torsional movement about an axis which runs parallel to the center axis of the contact element and centrally through the flexure hinge and a deflecting movement away from the contact element or transversely to the axis.

26. The connector as claimed in claim 17, wherein the transition between the flexure hinge and the front wall and/or between the flexure hinge and the rear wall is designed so that it is rounded with a rounding.

27. The connector as claimed in claim 17, wherein the clamping section has an activating tab via which a force can be exerted on the retaining web in such a way that the retaining web is movable from the clamping position into the release position.

28. The connector as claimed in claim 27, wherein, viewed in the direction of the retaining web, the activating tabs of two adjacent retaining webs are situated at the same position on the respective retaining webs in such a way that the two retaining webs are moved apart from each other from the clamping position into the release position by a tool which can be positioned between the activating tabs and act via the two activating tabs, and/or wherein the side wall has or provides an activating tab, wherein the adjacent retaining web is moved away from the side wall from the clamping position into the release position by a tool which acts on the activating tab of the side wall and the activating tab of the retaining web adjacent to the side wall.

29. The connector as claimed claim 17, wherein the contact element is designed externally with an essentially cylindrical shape, wherein the contact element has at least one recess in which the clamping structure engages.

30. The connector as claimed in claim 17, wherein the clamping structure has at least one hook, wherein the hook has a concave rounding for receiving the contact element, wherein the concave rounding, viewed in cross-section transversely to the center axis, has essentially the shape of a segment of a circle, in particular essentially the shape of a quarter circle.

31. The connector as claimed in claim 30, wherein two hooks are in each case arranged, situated opposite each other with respect to the intermediate space or the side wall, on two adjacent retaining webs, and form a hook pair, wherein one hook engages around the contact element from below with respect to the center axis and the other hook engages around the contact element from above with respect to the center axis.

32. The connector as claimed in claim 30, wherein two hooks are in each case arranged, situated opposite each other with respect to the intermediate space or the side wall, on two adjacent retaining webs, and form a hook pair, wherein one hook engages around the contact element from below with respect to the center axis and the other hook engages around the contact element from above with respect to the center axis and wherein at least two hook pairs are arranged so that they are offset relative to each other in the direction of the center axis of the contact element or the retaining web or the side wall, wherein the length of the hooks is the same or different between the individual hook pairs.

33. The connector as claimed in claim 17, wherein the clamping structure has a safety element, which provides a stop means with respect to movement of the contact element in the direction of the center axis of the contact element, on the retaining web or on the side wall; and/or
wherein, on the surface which faces the receiving space, the side walls have a clamping structure which has an essentially identical or similar design to that of the clamping structure on the retaining webs; and/or
wherein the front wall and the rear wall have an opening per contact element via which access to the contact element is provided, wherein preferably in each case two adjacent openings are situated so that they are offset downward and upward relative to each other in such a way that the contact elements also come to be situated offset relative to each other; and/or
wherein the contact element is an electrical contact element and has a front-side contact section which is designed as a socket part or pin part, and wherein the contact element has a rear-side contact section which is designed for connection to a cable.
